(19) United States
(12) Patent Application Publication
(10) Pub. No.: US 2024/0413580 A1
(43) Pub. Date: Dec. 12, 2024

(54) SECURING DEVICE HAVING INDICATOR ELEMENT AND OPTICALLY MODIFYING ELEMENT

(71) Applicant: Lisa Dräxlmaier GmbH, Vilsbiburg (DE)

(72) Inventors: Stefan WIMMER, Hohenthann (DE); Sebastian WILHELM, Schmelz (DE); Franziska NEUMAYER, Geisenhausen (DE)

(73) Assignee: Lisa Dräxlmaier GmbH, Vilsbiburg (DE)

(21) Appl. No.: 18/735,638

(22) Filed: Jun. 6, 2024

(30) Foreign Application Priority Data
Jun. 6, 2023 (DE) 102023114790.0

(51) Int. Cl. H01R 13/641; H01R 13/639

(52) U.S. Cl. CPC H01R 13/641; H01R 13/639

(57) ABSTRACT

A securing device for securing the locking of a locking element includes a locking element, which can be moved from a first locking position into a second locking position. The locking element produces locking in the second locking position. The securing device further includes an indicator element for indicating an item of information and an optically modifying element. In the first locking position of the locking element, the optically modifying element optically modifies a representation of the indicator element such that the indicator element is not able to indicate an item of information. In the second locking position of the locking element, the optically modifying element does not optically modify the representation of the indicator element such that the indicator element indicates an item of information.

### CROSS-REFERENCE TO RELATED APPLICATIONS

This application claims priority to and the benefit of DE 10 2023 114 790.0 filed on Jun. 6, 2023. The disclosure of the above-referenced application is incorporated herein by reference.

### FIELD

The present disclosure relates to a securing device to secure the locking of a locking element.

### BACKGROUND

The statements in this section merely provide background information related to the present disclosure and may not constitute prior art.

CPA (connector position assurance) systems are intended to inhibit a connector housing latched to a mating connector housing from being inadvertently detached from the mating connector housing, as can happen for example due to vibrations, temperature-related expansion or shrinkage, pulling on a cable accommodated in the connector housing, or other mechanical effects. For this, the CPA system is responsible for locking the connector to its mating connector, as the last element to be operated. In order to provide secure locking here, it is desired for the final state of the locking to be detected by virtue of a scannable element and for this element to be readable when the CPA system is finally closed.

### SUMMARY

This section provides a general summary of the disclosure and is not a comprehensive disclosure of its full scope or all of its features.

The present disclosure relates to a securing device having an indicator element and an optically modifying element. The securing device serves to secure the locking of a locking element or for connector position assurance (CPA) and can be used to secure the locking of a connector housing to a mating connector housing. In particular, the present disclosure relates to a CPA system having a detected element which is optically manipulated.

The present disclosure provides a suitable device to reliably identify if locking is present or not, in particular for connectors for which CPA locking is desired.

The connector may have a high degree of automation in terms of production and fabrication to make the use of a scannable element desired as an assurance function. The present disclosure relates to a securing device having an indicator element and an optically modifying element, wherein the indicator element is optically modified by the optically modifying element and can be used as scannable element, in order to thus provide reliable assurance of the connector production process and make it possible to scan the plug system in the assembled state. The solution presented here can be applied to various plug systems and can be easily adapted from one plug system to another plug system.

The present disclosure provides for optical manipulation of the detectable element, or the indicator element. Provided the CPA system is not in the final position, the element to be detected cannot be discerned such that it gives the desired feedback. Only in the final position of the CPA system is the element correctly represented. The element can thus be discerned, since any optical manipulation of an element to be detected is affected in combination with the CPA function.

The indicator element is on the CPA system and is optically modified by an element (referred to as optically modifying element here) which is, for example, on the clip. This optical modification means that the element to be detected (here referred to as indicator element) cannot be discerned correctly and does not give any feedback. The element is represented correctly and can be detected only once the CPA system has been actuated.

As described in more detail below in relation to FIGS. 2A and 2B, the indicator element is not concealed; it is always visible. However, the representation of the element to be detected (represented by a DMC in the example) is outwardly optically modified by, for example, a lens, prism or a frosted element.

According to a first aspect, the present disclosure provides a securing device for securing the locking of a locking element, wherein the securing device includes the following: a locking element, which can be moved from a first locking position into a second locking position, wherein the locking element produces locking in the second locking position; an indicator element for indicating an item of information; and an optically modifying element, which, in the first locking position of the locking element, optically modifies a representation of the indicator element, with the result that the indicator element is not able to indicate an item of information; wherein, in the second locking position of the locking element, the optically modifying element does not optically modify the representation of the indicator element, with the result that the indicator element indicates the item of information.

Such a securing device affords the technical advantage that it is possible to securely and reliably discern locking. The indicator element can be detected via a scannable element, with the result that it is possible to reliably automatically discern the position of the locking element. This also makes it possible to automatically detect the state of connectors for which CPA locking is desired. The securing device thus meets the standards for CPA locking. The item of information may, for example, include existing or non-existing locking by the locking element.

An optically modifying element, as described here, is an optical element which modifies the optical representation of the indicator element via optical displacement, with the result that the indicator element has a different optical representation than it does without such an optical modification. The modified optical representation has the effect that the information content optically represented by the indicator element can no longer be detected by virtue of a scannable element. An optical modification is, for example, an optical distortion, a light refraction, an optical clouding or the like. The information content represented by the indicator element is, for example, a code, e.g. in two-dimensional form, such as a DMC or a barcode or the like. Owing to the optical modification, this code can no longer be discerned or read by a scannable element.

According to one example of the securing device, in both of the locking positions of the locking element, the indicator element is not concealed and always remains visible.

This affords the technical advantage that covering the indicator element to achieve the desired effect of non-discernibility may be omitted. The optical modification in the representation is already sufficient to make the indicator element unrecognizable, so that it can no longer be detected or scanned by a scannable element.

According to one example of the securing device, the optically modifying element includes an optical lens or an optical prism, which, in the first locking position of the locking element, is positioned above the indicator element and optically distorts at least part of the representation of the indicator element.

This affords the technical advantage that a lens and a prism can be produced easily and effectively to result in a distortion of the representation of the indicator element, with the result that the optical item of information of the indicator element can no longer be discerned by a reader.

According to one example of the securing device, the optically modifying element includes an opaque optical element, which, in the first locking position of the locking element, is positioned above the indicator element and optically clouds at least part of the representation of the indicator element.

This affords the technical advantage that such an opaque optical element can be produced easily and effectively to result in the clouding of the representation of the indicator element, with the result that the optical item of information of the indicator element can no longer be discerned by a reader.

The opacity, also referred to as clouding or shading, is the opposite of transparency, which is to say a lack of transparency, or lack of permeability. An opaque optical element is thus an optical element which has the effect of clouding, obscuring or muddying the optical representation. An example of such an opaque optical element is frosted glass, also referred to as opaque clear glass, which is permeable to light, but not transparent. Cloudy glass, a frosted clear glass, is also not transparent. Frosted glass is, for example, a glass colored by admixing an opacifying substance, or glass made non-transparent by roughening the surface, or a composite of a transparent glass layer with a clear glass layer.

According to one example of the securing device, the indicator element includes an identifying feature, which, in the first locking position of the locking element, is optically modified by the optically modifying element in such a way that it is no longer readable.

This affords the technical advantage that the indicator element can communicate all types of information, for example information about the type of locking, the designation of the components, etc.

According to one example of the securing device, the identifying feature includes a code having multiple elements, for example a one-, two- or three-dimensional code or in particular a data matrix code, DMC.

The data matrix code is one of the best known 2D codes and can be used for permanent and robust direct labelling. The DMC is variable in size and thus permits a multiplicity of symbol elements.

According to one example of the securing device, the indicator element is placed on the locking device and, in the first locking position, is positioned underneath the optically modifying element; and a movement of the locking element from the first locking position into the second locking position moves the indicator element away from the optically modifying element.

This affords the technical advantage that the indicator element can reliably and robustly indicate locking. In the first locking position, the indicator element is underneath the optically modifying element and thus has an unrecognizable representation, with the result that locking cannot be discerned by virtue of a scannable element. In the second locking position, the indicator element is slid out under the optically modifying element or moved away from the optically modifying element, with the result that the indicator element can be clearly discerned and read by virtue of the scannable element, which in this position reliably discerns locking.

According to one example of the securing device, the indicator element is discernible when the representation of the indicator element is not optically modified by the optically modifying element.

This affords the technical advantage that the state of the locking element can be discerned securely and reliably, for example via a reader or a scanner to efficiently assure automated mounting of plug systems.

According to one example of the securing device, the securing device is designed to perform connector position assurance (CPA) to secure the locking of a connector housing to a mating connector housing.

This affords the technical advantage that the state of the CPA system can be reliably detected by virtue of a scannable element, which is readable only when the CPA system is finally closed.

According to one example of the securing device, the securing device also includes: a clamping element for clamping the connector housing into the mating connector housing, wherein the clamping element can be moved from an open clamping-element position, in which the connector housing can be inserted into the mating connector housing, into a closed clamping-element position, in which the connector housing is fastened to the mating connector housing with electrical contact; wherein the locking element is placed on the clamping element and designed to lock or to unlock the clamping element.

This affords the technical advantage that the indicator element can reliably indicate an item of information about the locking of the clamping element, for example a clip, so that the state of the clamping element can be efficiently detected via a scannable element.

According to one example of the securing device, in the closed clamping-element position, the locking element can be moved from the first locking position into the second locking position and is designed, in the second locking position, to lock the clamping element in the closed clamping-element position and, in the first locking position, to unlock the clamping element for a movement into the open clamping-element position.

This affords the technical advantage that a secure connection of the connector housing to the mating connector housing via the clamping element is provided. The securing device thus meets the standards for CPA locking.

According to one example of the securing device, the optically modifying element is placed on the clamping element; and the indicator element is placed on the locking element; and wherein a movement of the locking element from the first locking position into the second locking position slides the indicator element out from under the optically modifying element, with the result that the representation of the indicator element is not optically modified by the optically modifying element.

This affords the technical advantage that the indicator element can reliably and robustly indicate locking. In the first locking position, the indicator element is underneath the optically modifying element and thus has an unrecognizable representation, with the result that locking cannot be discerned by virtue of a scannable element. In the second locking position, the indicator element is slid out from under the optically modifying element, with the result that the indicator element is no longer optically modified by this element and can be reliably read by virtue of the scannable element and thus locking can be discerned.

According to a second aspect, the present disclosure provides a plug connection having a connector housing and a mating connector housing, which are connected to one another and secured by a securing device according to the first aspect.

According to a third aspect, the present disclosure provides a securing system including a securing device according to the first aspect and a reader, wherein the reader is designed to detect the indicator element when the locking element is in the second locking position, in order to discern locking.

According to one example of the securing system, the reader is designed to detect the indicator element only when the locking element is in the second locking position and to detect correct locking only in this position.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 shows a schematic illustration of the states of a securing device according to the present disclosure;

FIG. 2A shows an illustration of a securing device according to the present disclosure as per a first example in the first locking position, with an optically modified representation of the indicator element;

FIG. 2B shows an illustration of the securing device of FIG. 2A in the second locking position, without an optically modified representation of the indicator element;

FIG. 3A shows an illustration of a securing device according to the present disclosure as per a second example in the first locking position, with an optically modified representation of the indicator element;

FIG. 3B shows an illustration of the securing device of FIG. 3A in the second locking position, without an optically modified representation of the indicator element;

FIG. 4A shows an illustration of a securing device according to the present disclosure as per a third example in the first locking position, with an optically modified representation of the indicator element;

FIG. 4B shows an illustration of the securing device of FIG. 4A in the second locking position, without an optically modified representation of the indicator element;

FIG. 5A shows a perspective view illustration of a securing device including a locking element, an indicator element and a clamping element in a closed clamping-clip position and a locking element in a first locking position; and

FIG. 5B shows a perspective view of the securing device of FIG. 5A, in the case of which the locking element is in a second locking position.

The figures are merely schematic illustrations and serve only to explain the present disclosure. Elements that are the same or have the same effect are provided with the same reference signs throughout.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features. In the detailed description that follows, reference is made to the accompanying drawings, which form a part thereof and which show, as an illustration, specific examples in which the present disclosure can be carried out. It goes without saying that other examples can also be used and structural or logical changes can be made without departing from the concept of the present disclosure. The detailed description should therefore not be understood in a restrictive sense. It also goes without saying that the features of the various examples described herein can be combined with one another unless specifically stated otherwise.

The aspects and examples are described with reference to the drawings, wherein reference signs that are the same generally relate to the same elements. Numerous specific details are set out for the purposes of explanation in the description that follows in order to provide an in-depth understanding of one or more aspects of the present disclosure. However, it may be obvious to a person skilled in the art that one or more aspects or examples can be implemented with a lesser degree of the specific details. In other cases, known structures and elements are illustrated in a schematic form in order to make it easier to describe one or more aspects or examples. It goes without saying that other examples can be used and structural or logical changes can be made without departing from the concept of the present disclosure.

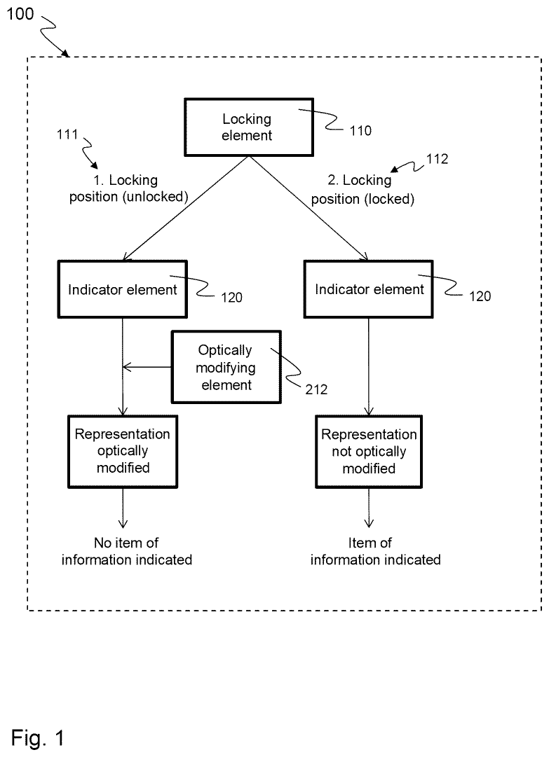

FIG. 1 shows a schematic illustration of the states of a securing device 100 according to the present disclosure.

The securing device 100 serves to secure the locking of a locking element 110. The securing device 100 includes a locking element 110, an indicator element 120 and an optically modifying element 212.

The locking element 110 can be moved from a first locking position 111 into a second locking position 112 and produces locking in the second locking position 112.

The indicator element 120 serves to indicate an item of information, for example an item of information about the locking by the locking element 110. The item of information can be represented in any suitable form.

In the first locking position 111 of the locking element 110, the optically modifying element 212 optically modifies a representation of the indicator element 120 in such a way that the indicator element 120 is not able to indicate an item of information.

In the second locking position 112 of the locking element 110, the optically modifying element 212 does not modify the optical representation of the indicator element 120, with the result that the indicator element 120 indicates the item of information.

In both of the locking positions 111, 112 of the locking element 110, the indicator element 120 is not concealed and always remains visible.

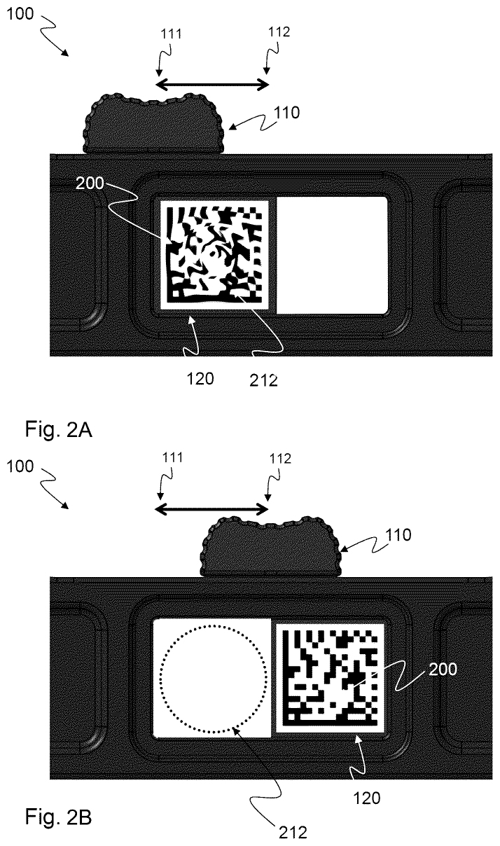

Various examples of the optically modifying element 212 and associated description are illustrated and described in more detail in FIGS. 2A, 2B, 3A, 3B, 4A and 4B.

In the securing devices 100 shown in FIGS. 2A, 2B, 3A, 3B, 4A and 4B, the indicator element 120 is not concealed and is always visible. However, the representation of the element 120 to be detected (represented by a DMC in the example) is outwardly optically modified by, for example, a lens, prism or a frosted element.

FIGS. 2A and 2B show illustrations of a securing device 100 according to the present disclosure as per a first example in the first locking position (FIG. 2A), with optically modified representation of the indicator element 120, and in the second locking position (FIG. 2B), without optically modified representation of the indicator element 120.

The securing device 100 in FIG. 2A and FIG. 2B corresponds to the securing device described above in relation to FIG. 1, with FIG. 2A and FIG. 2B illustrating the structure of this securing device 100 in more detail.

As already described above in relation to FIG. 1, the securing device 100 serves to secure the locking of a locking element 110. The securing device 100 includes a locking element 110, an indicator element 120 and an optically modifying element 212, as illustrated in FIGS. 2A and 2B.

The locking element 110 can be moved from a first locking position 111 into a second locking position 112 and produces locking in the second locking position 112. FIG. 2A illustrates the locking element 110 in the first locking position; FIG. 2B illustrates the locking element in the second locking position.

The indicator element 120 serves to indicate an item of information, for example an item of information regarding locking or non-locking by the locking element 110.

In the first locking position 111 of the locking element 110 (see FIG. 2A), the optically modifying element 212 optically modifies a representation of the indicator element 120 in such a way that the indicator element 120 is not able to indicate an item of information.

In the second locking position 112 of the locking element 110 (see FIG. 2B), the optically modifying element 212 does not modify the optical representation of the indicator element 120, with the result that the indicator element 120 indicates the item of information.

In both of the locking positions 111, 112 of the locking element 110, the indicator element 120 is not concealed and always remains visible, as shown in FIGS. 2A and 2B.

In the example of FIGS. 2A and 2B, the optically modifying element 212 is an optical lens, which, in the first locking position 111 of the locking element 110 (see FIG. 2A), is positioned above the indicator element 120 and optically distorts at least part of the representation of the indicator element 120. FIGS. 2A and 2B show that the optically modifying element 212 or lens is placed in the middle above the indicator element. It goes without saying that other positions are also possible, for example in a corner above the indicator element or above one side of the indicator element 120. It is also possible to place multiple such optically modifying elements 212 or optical lenses, which may also have different sizes, above the indicator element 120.

As shown in FIGS. 2A and 2B, the indicator element 120 includes an identifying feature 200, for example a code, for example a one-, two- or three-dimensional code, which, in the first locking position 111 of the locking element 110 (see FIG. 2A), is optically modified by the optically modifying element 212 in such a way that it is no longer readable. Although a reader can still detect the outlines of the code, a user can no longer read it or discern it.

The identifying feature 200 or two-dimensional code may be, for example, a data matrix code, DMC. However, it may, for example, also be a barcode.

Such a data matrix code includes or consists of, for example, the following main components:
1) two pairs of solid continuous edges and interrupted edges as boundary lines (finder pattern or position marker). The solid boundary lines serve for delimitation. They are used to align and equalize the data matrix code, so that any reading angle is possible.
2) a peripheral quiet zone. This empty zone surrounds the data matrix code. It does not contain any information or patterns. The width of the quiet zone is at least one gap or line (in one example four times the width, or height, of a module) and is desired for delimitation from other optical image elements of the surrounding area.
3) the corner situated opposite the closed edges. This corner makes it possible to quickly discern the code schemata. In the case of identifying feature 200 or code scheme ECC, with an even number of lines and gaps, the element in the upper right-hand corner is white. In the case of the other standardized code schemata, with an odd number of lines and gaps, the element in the upper right-hand corner is black.
4) the alignment pattern. This combination in pairs of continuous and interrupted lines in both directions, horizontally and vertically, makes it easier to evaluate the image. They subdivide large data fields into equally sized parts in the case of codes with an edge length of at least 32 modules.
5) the data area. This data area contains the actual binary information in coded form. Depending on the size of the matrix, the number of possible items of information is also defined in this way.

As shown in FIGS. 2A and 2B, the indicator element 120 is placed on the locking element 110 and, in the first locking position 111, is positioned underneath the optically modifying element 212 (see FIG. 2A).

A movement of the locking element 110 from the first locking position 111 into the second locking position 112 moves the indicator element 120 away from the optically modifying element 212 (see the transition from FIG. 2A to FIG. 2B).

The indicator element 120 is discernible and can be read, for example by means of a reader, when the representation of the indicator element 120 is not optically modified by the optically modifying element 212, i.e. when the locking element 110 is in the second locking position 112, as illustrated in FIG. 2B.

In particular, FIGS. 2A and 2B show the CPA system. The DMC is on the CPA system. The DMC is visible, but is optically modified by a lens, which is on the clip (black).

Owing to this optical modification, the code cannot be read in this position. Only after the CPA system has been actuated (FIG. 2B) can it be read, since the lens no longer influences the representation.

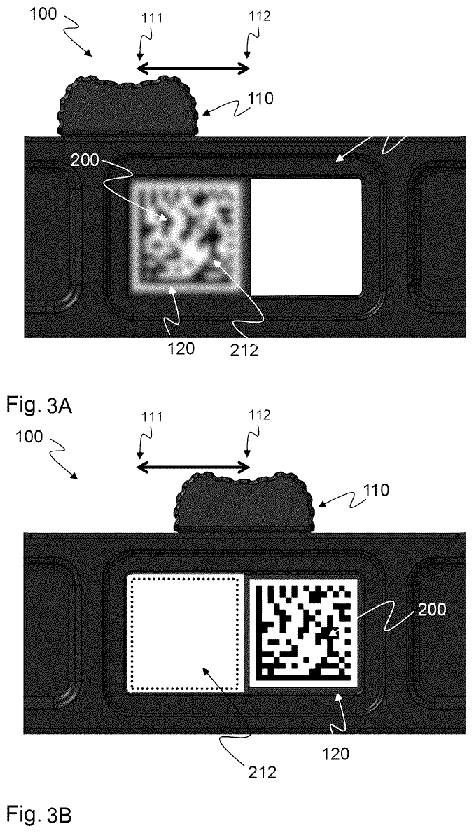

FIGS. 3A and 3B show illustrations of a securing device 100 according to the present disclosure as per a second example in the first locking position (FIG. 3A), with optically modified representation of the indicator element 120, and in the second locking position (FIG. 3B), without optically modified representation of the indicator element 120.

The securing device 100 in FIG. 3A and FIG. 3B corresponds to the securing device described above in relation to FIGS. 2A and 2B, with the optically modifying element 212 in FIG. 3A and FIG. 3B being not an optical lens but an optical prism.

As already described above in relation to FIGS. 2A and 2B, the securing device 100 serves to secure the locking of a locking element 110. The securing device 100 includes a locking element 110, an indicator element 120 and an optically modifying element 212, as illustrated in FIGS. 3A and 3B. The locking element 110 can be moved from a first locking position 111 into a second locking position 112 and produces locking in the second locking position 112. FIG. 3A illustrates the locking element 110 in the first locking position; FIG. 3B illustrates the locking element in the second locking position. The indicator element 120 serves to indicate an item of information, for example an item of information about locking or non-locking by the locking element 110.

In the first locking position 111 of the locking element 110 (see FIG. 3A), the optically modifying element 212, here in FIGS. 3A and 3B an optical prism, optically modifies a representation of the indicator element 120 in such a way that the indicator element 120 is not able to indicate an item of information.

In the second locking position 112 of the locking element 110 (see FIG. 3B), the optically modifying element 212, here in FIGS. 3A and 3B an optical prism, does not modify the optical representation of the indicator element 120, with the result that the indicator element 120 can indicate an item of information.

Such an optical prism is an optical component in the form of the prism geometric body, which is used for different optical effects, e.g. as a dispersive element, which fans out light according to wavelengths, or to deflect a beam of light. The optical properties of the prism substantially depend on the triangle angles or the position of the optically effective prism faces in relation to one another and on the refractive index of the material, for example glass or transparent plastic.

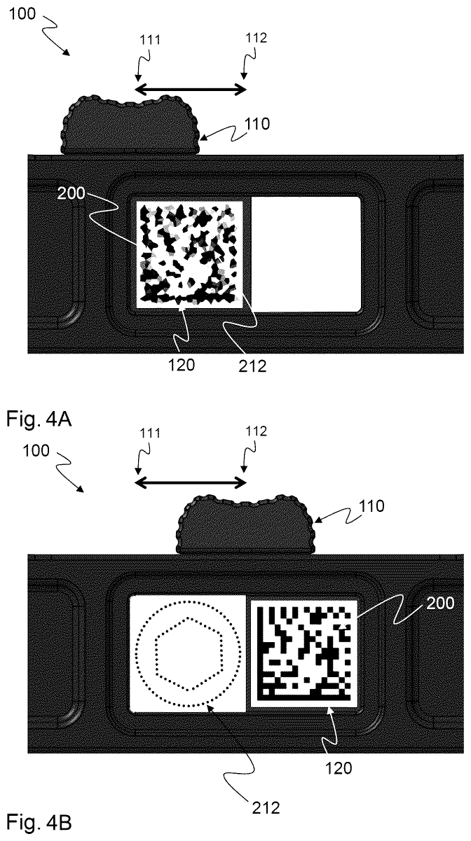

FIGS. 4A and 4B show illustrations of a securing device 100 according to the present disclosure as per a third example in the first locking position (FIG. 4A), with optically modified representation of the indicator element 120, and in the second locking position (FIG. 4B), without optically modified representation of the indicator element 120.

The securing device 100 in FIG. 4A and FIG. 4B corresponds to the securing device described above in relation to FIGS. 2A and 2B and also 3A and 3B, with the optically modifying element 212 in FIG. 4A and FIG. 4B being not an optical lens or prism but an opaque optical element, for example frosted glass.

As already described above in relation to FIGS. 2A and 2B, the securing device 100 serves to secure the locking of a locking element 110. The securing device 100 includes a locking element 110, an indicator element 120 and an optically modifying element 212, as illustrated in FIGS. 4A and 4B. The locking element 110 can be moved from a first locking position 111 into a second locking position 112 and produces locking in the second locking position 112. FIG. 4A illustrates the locking element 110 in the first locking position 111; FIG. 4B illustrates the locking element 110 in the second locking position 112. The indicator element 120 serves to indicate an item of information, for example an item of information about locking or non-locking by the locking element 110. Other items of information can also be indicated via the indicator element 120.

The effect of the optically modifying element 212 or opaque optical element is to cloud, shade, darken or muddy the optical representation of the indicator element 120, which is to say a lack of transparency or lack of permeability to light, with the result that the indicator element 120 can no longer be read by a scannable element. It may, for example, be frosted glass, also referred to as opaque clear glass, which is permeable to light, but not transparent. It may also be cloudy glass, which is a non-transparent, frosted clear glass. The opaque optical element may be produced, for example, by admixing an opacifying substance with glass. The optical opaque element may be glass made non-transparent by roughening the surface, or a composite of a transparent glass layer with a clear glass layer.

In the first locking position 111 of the locking element 110 (see FIG. 4A), the optically modifying element 212, here in FIGS. 4A and 4B the opaque optical element, optically modifies a representation of the indicator element 120 in such a way that the indicator element 120 is not able to indicate an item of information.

In the second locking position 112 of the locking element 110 (see FIG. 4B), the optically modifying element 212, here in FIGS. 4A and 4B the opaque optical element, does not modify the optical representation of the indicator element 120, with the result that the indicator element 120 can indicate an item of information.

As illustrated in FIGS. 2A, 2B, 3A, 3B and 4A, 4B, there are various possible examples for the securing device 100. In the examples shown, a transparent element which modifies the representation (referred to as optically modifying element 212 here) is always above the indicator element 120. The indicator element 120 is thus not exposed, since there is always something above it. Exposing something, however, also means making something visible. With this approach, the DMC is always visible; it is only the representation that is distorted or optically modified in any way. In the examples shown, the CPA system is in the clip (black) and makes a lateral movement; for this, there are of course also X-variants.

The securing device 100, as described above in relation to FIGS. 1 to 4B, and a reader make it possible to implement a securing system which can reliably determine the state of the locking element 110 and transfer this state, for example to a controller, for further processing. Such a securing system includes a securing device 100 as described above and a reader. The reader is designed to detect the indicator element 120 when the locking element 110 is in the second locking position, i.e. when the indicator element 120 is detectable, in order to thus detect locking.

The reader may be designed to detect the indicator element 120 only when the locking element 110 is in the second locking position 112 and to detect correct locking only in this second locking position 112.

The reader may forward the detected information, for example the read-out 2D code, to a controller, which then can indicate a fault if it detects one and take corresponding steps to control the production process.

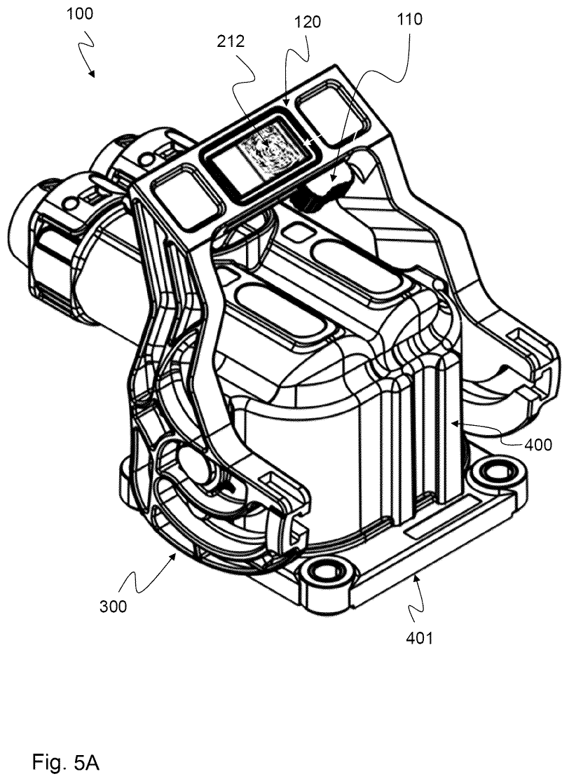

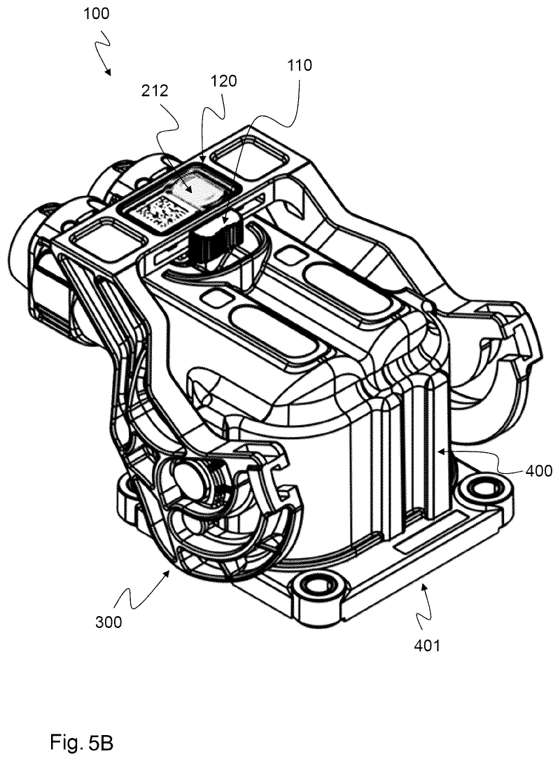

FIGS. 5A and 5B show perspective views of a securing device 100 including a locking element 110, an indicator element 120 and a clamping element 300 in a closed clamping-clip position. The locking element 110 is illustrated in the first locking position 111 in FIG. 5A. It can be moved from the first locking position 111 into the second locking position 112. The second locking position 112 is illustrated in FIG. 5B.

The securing device 100 is designed to perform connector position assurance (CPA) to secure the locking of a connector housing 400 to a mating connector housing 401.

In addition to the locking element 110, indicator element 120 and optically modifying element 212 that are already described above, the securing device 100 also includes a clamping element 300, for example a clamping clip, for clamping the connector housing 400 into the mating connector housing 401.

The clamping element 300 can be moved from an open clamping-element position, in which the connector housing 400 can be inserted into the mating connector housing 401, into a closed clamping-element position, in which the connector housing 400 is fastened to the mating connector housing 401 with electrical contact.

The locking element 110 is placed on the clamping element 300, as illustrated in FIGS. 5A and 5B and is designed to lock or to unlock the clamping element 300.

The indicator element 120 indicates an item of information, for example an item of information about locking or non-locking of the clamping element 300 by the locking element 110. The indicator element 120 may, for example, be configured in accordance with the illustration in FIGS. 2A to 4B. It may, for example, be integrated in a panel on the clamping element 300, as illustrated in FIGS. 5A and 5B.

In the closed clamping-element position, the locking element 110 can be moved from the first locking position 111 (as illustrated in FIG. 5A) into the second locking position 112 (as illustrated in FIG. 5B). The locking element 110 is designed, in the second locking position 112, to lock the clamping element 300 in the closed clamping-element position and, in the first locking position 111, to unlock the clamping element 300 for a movement into the open clamping-element position. FIG. 5A illustrates an intermediate position of the clamping element 300, into which the clamping element 300 can be brought when the locking element 110 is unlocked. The identifying feature 200 cannot be seen in FIG. 5A.

The optically modifying element 212 is placed on the clamping element 300, as can be seen in FIGS. 5A and 5B. The indicator element 120 is also placed on the locking element 110, as can be seen in FIGS. 5A and 5B. The optically modifying element 212 modifies the identifying feature 200 in FIG. 5A, with the result that the identifying feature 200 is not discernible. It is therefore not possible to discern an item of information, in particular an item of information about locking.

In the event of a movement of the locking element 110 from the first locking position 111 (see FIG. 5A) into the second locking position 112 (see FIG. 5B), the indicator element 120 is slid out from under the optically modifying element 212, as illustrated in FIG. 5B, with the result that the representation of the indicator element 120 is not optically modified by the optically modifying element 212 and the item of information is discernible.

FIGS. 5A and 5B thus also show a plug connection having a connector housing 400 and a mating connector housing 401, which are connected to one another and secured by the securing device 100 as described above.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A securing device for securing a locking of a locking element, comprising:
the locking element configured to move from a first locking position into a second locking position, the locking element configured to lock in the second locking position;
an indicator element configured to indicate the lock of the locking element; and
an optically modifying element that in the first locking position of the locking element, is configured to optically modify a representation of the indicator element such that the indicator element is not able to indicate an item of information and in the second locking position of the locking element, the optically modifying element is configured to not optically modify the representation of the indicator element such that the indicator element indicates the item of information.

2. The securing device according to claim 1, wherein, in both the first locking position and the second locking position of the locking element, the indicator element is not concealed and always remains visible.

3. The securing device according to claim 1,
wherein the optically modifying element includes an optical lens or an optical prism, which, in the first locking position of the locking element, is positioned above the indicator element and optically distorts at least part of the representation of the indicator element.

4. The securing device according to claim 1,
wherein the optically modifying element includes an opaque optical element, which, in the first locking position of the locking element, is positioned above the indicator element and optically clouds at least part of the representation of the indicator element.

5. The securing device according to claim 1,
wherein the indicator element includes an identifying feature configured to be read, which, in the first locking position of the locking element, the identifying feature is optically modified by the optically modifying element in such a way that it is no longer readable.

6. The securing device according to claim 5,
wherein the identifying feature includes a code.

7. The securing device according to claim 1,
wherein the indicator element is placed on the locking element and, in the first locking position, is positioned underneath the optically modifying element; and
wherein a movement of the locking element from the first locking position into the second locking position moves the indicator element away from the optically modifying element.

8. The securing device according to claim 1,
wherein the indicator element is discernible when the representation of the indicator element is not optically modified by the optically modifying element.

9. The securing device according to claim 1,
wherein the securing device is configured to perform connector position assurance (CPA) to secure the lock between a connector housing and a mating connector housing.

10. The securing device according to claim 9, further comprising:
a clamping element for clamping the connector housing into the mating connector housing, wherein the clamping element is configured to move from an open clamping-element position, in which the connector housing is configured to be inserted into the mating connector housing, into a closed clamping-element position, in which the connector housing is fastened to the mating connector housing with electrical contact; and
wherein the locking element is placed on the clamping element and configured to lock or to unlock the clamping element.

11. The securing device according to claim 10,
wherein, in the closed clamping-element position, the locking element is configured to move from the first locking position into the second locking position and is configured, in the second locking position, to lock the clamping element in the closed clamping-element position and, in the first locking position, to unlock the clamping element for a movement into the open clamping-element position.

12. The securing device according to claim 11, wherein the optically modifying element is placed on the clamping element, the indicator element is placed on the locking element, and a movement of the locking element from the first locking position into the second locking position is configured to slide the indicator element out from under the optically modifying element so that the representation of the indicator element is not optically modified by the optically modifying element.

13. The securing device according to claim 10, wherein the optically modifying element is placed on the clamping element, the indicator element is placed on the locking element, and a movement of the locking element from the first locking position into the second locking position is configured to slide the indicator element out from under the optically modifying element so that the representation of the indicator element is not optically modified by the optically modifying element.
